(19) United States
(12) Patent Application Publication
(10) Pub. No.: US 2020/0287622 A1
(43) Pub. Date: Sep. 10, 2020

(54) METHOD FOR EQUIPMENT SELECTION IN GENERALIZED MULTIPROTOCOL LABEL SWITCHING

(71) Applicant: CENTRE FOR DEVELOPMENT OF TELEMATICS, BANGALORE (IN)

(72) Inventors: Abhishek RAI, New Delhi (IN); Aditya Veer SINGH, New Delhi (IN)

(73) Assignee: CENTRE FOR DEVELOPMENT OF TELEMATICS, BANGALORE (IN)

(21) Appl. No.: 16/291,750

(22) Filed: Mar. 4, 2019

(51) Int. Cl. H04B 10/032; H04L 12/723; H04L 12/707; H04L 12/46; H04Q 11/00; H04L 12/781

(52) U.S. Cl. CPC H04B 10/032; H04L 45/507; H04L 45/22; H04Q 2011/0081; H04Q 11/0066; H04L 45/52; H04L 12/4633

(57) ABSTRACT

A method of synchronizing state of a Label Switched Path (LSP) of a Generalized Multiprotocol Label Switching (GMPLS) based optical communication network with that of a data plane of the network is disclosed. The method includes: receiving, at a network device, Resource ReserVation Protocol (RSVP) path objects that include at least one private object, wherein the at least one private object carries information that enables control plane of the network to synchronize at least one node downstream of the LSP; and synchronizing, using the network device, the state of the LSP with state of the data plane based on the at least one private object. The at least one private object can include one or more specific structures that enable the at least one node to uniquely identify and program equipment operatively connected with the at least one node.

### FIELD OF DISCLOSURE

The present disclosure relates to telecommunications. In particular it relates to optical telecommunication networks.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

Multiprotocol Label Switching (MPLS) is a type of data-carrying technique for high-performance telecommunications networks, such as optical telecom networks. MPLS directs data from one network node to the next based on short path labels rather than long network addresses, avoiding complex lookups in a routing table. The labels identify virtual links (paths) between distant nodes rather than endpoints. MPLS can encapsulate packets of various network protocols, hence its name “multiprotocol”. MPLS supports a range of access technologies, including T1/E1, ATM, Frame Relay, and DSL.

MPLS is a scalable, protocol-independent transport. In an MPLS network, data packets are assigned labels. Packet-forwarding decisions are made solely on the contents of this label, without the need to examine the packet itself. This allows one to create end-to-end circuits across any type of transport medium, using any protocol. The primary benefit is to eliminate dependence on a particular OSI model data link layer (layer 2) technology, such as Asynchronous Transfer Mode (ATM), Frame Relay, Synchronous Optical Networking (SONET) or Ethernet, and eliminate the need for multiple layer-2 networks to satisfy different types of traffic. Multiprotocol label switching belongs to the family of packet-switched networks.

GMPLS (Generalized Multiprotocol Label Switching), also known as Multiprotocol Lambda Switching, is a technology that provides enhancements to Multiprotocol Label Switching (MPLS) to support network switching for time, wavelength, and space switching as well as for packet switching. In particular, GMPLS provides support for photonic networking, also known as optical communications.

However, a Legacy Optical Transport system has a tight coupling with the hardware and direction that it caters, which leads to one to one provisioning of Network Equipment via EMS/NMS (Element Management System/Network Management System) or Local Craft Terminals. With the advancement of Optical Hardware and support of Colorless, Directionless, and Contention less (CDC) Reconfigurable Optical Add Drop Multiplexer (ROADM) in DWDM (Dense Wavelength Division Multiplexing) systems along with the arrival of ASON/GMPLS (Automatically Switched Optical Network/Generalized Multiprotocol Label Switching) network operators/administrators have the advantage of circuit creation and provisioning of Optical hardware via a single point mostly through the use of signaling protocol like RSVP (Resource ReserVation Protocol) in GMPLS.

State of the art ROADM technology allows operators to not only drop any wavelength (colorless) at any node (directionless) and from multiple directions (contention less), but to also send any wavelengths in any direction (directionless) using any available port on the network node (colorless). This so-called CDC architecture (colorless, directionless, contention less—any wavelength, any node, any time) is fully flexible and non-blocking.

However, present GMPLS standard does not specify any method to create a restoration LSP (Label Switched Path) in addition to working and protection LSP. There exists one RFC 8131 that specifies mechanism to create restoration LSP via association object but doesn't provide the complete picture for selection and provision of wavelength and direction toof the redundant hardware in case of CDC ROADM.

Further, currently, there is no way available in the RSVP packets to link the current LSP with all of the associated LSP (protection or restoration), which is required for finding correct hardware to be programmed, so there exists a gap in current standard to select redundant hardware. Also since upper bound for switchover time is 50 ms for 1+1, selection is done on the tail and head node (of an LSP) independently and does not involve control plane. Control plane is only involved in programming the upgraded LSP as protection or working LSP. In such scenarios for some time Rx path of both nodes may not be in sync and if a tunnel programmed during this time there can be service disruption for greater than 50 ms.

Hence there is a need in the art for a method to create a restoration LSP (Label Switched Path) in addition to working and protection LSP. The method should enable RSVP packets to link a current LSP with all associated LSPs (either for protection or for restoration) so as to find/select correct/redundant hardware to be programmed.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS OF THE INVENTION

Some of the objects of the present disclosure, which at least one embodiment herein satisfies are as listed herein below.

It is an object of the present disclosure to provide for a method that enables RSVP packets to link current LSP with all associated LSPs in a network in order to find correct/redundant hardware to be programmed.

It is another object of the present disclosure to provide a method to create a restoration LSP (Label Switched Path) in addition to working and protection LSP.

It is yet another object of the present disclosure to provide a method to keep Rx path of various nodes in an LSP in sync so as to have minimum service disruption time.

### SUMMARY

The present disclosure mainly relates to optical telecom networks. In particular, it relates to a method for equipment selection in a GMPLS network.

In an aspect, present disclosure elaborate upon a method of synchronizing state of a Label Switched Path (LSP) of a Generalized Multiprotocol Label Switching (GMPLS) based optical communication network with that of a data plane of the network. The method includes: receiving, at a network device, Resource ReserVation Protocol (RSVP) path objects that comprise at least one private object, wherein the at least one private object carries information that enables control plane of the network to synchronize at least one node downstream of the LSP; and synchronizing, using the network device, the state of the LSP with state of the data plane based on the at least one private object.

In another aspect, the at least one private object can include one or more specific structures that enable the at least one node to uniquely identify and program equipment operatively connected with the at least one node, wherein the at least one private object can be of Type-Length-Value (TLV) format, and can carry information pertaining to a restoration LSP or a protection LSP.

In an aspect, the at least one private object can piggyback on the RSVP path objects to carry the information from one node to another of the network.

In another aspect, the method can facilitate a mechanism to identify hardware for provisioning of restoration paths in a tunnel following 1+1+R protection scheme.

In another aspect, the control plane can choose the LSP's head node as master and can enforce configuration and card selected to the at least one node.

In yet another aspect, the method can be applicable to all network topologies.

In an aspect, the method can enable implementation of ASON (Automatically Switched Optical Network) to create more than two paths to support 1+1+R protection during span of multiple cuts in optical fibre used in the network.

In another aspect, the method can enable the RSVP path objects to link current LSP with all LSPs in the network in order to find correct/redundant hardware to be programmed.

In yet another aspect, the method can enable Rx path of various nodes in the LSP to be kept in sync so as to have minimum disruption time.

In an aspect present disclosure elaborates upon a network device configured in a Generalized Multiprotocol Label Switching (GMPLS) based optical communication network having a Label Switched Path (LSP). The network device includes one or more processors coupled with a memory, the memory storing instructions executable by the one or more processors to: receive, at the network device, Resource ReserVation Protocol (RSVP) path objects that comprise at least one private object, wherein the at least one private object carries information that enables control plane of the network to synchronize at least one node downstream of the LSP; and synchronize, using the network device, state of the LSP with data plane of the network based on the at least one private object.

Various objects, features, aspects and advantages of the present disclosure will become more apparent from the following detailed description of preferred embodiments, along with the accompanying drawing figures in which like numerals represent like features.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIGS. 1A to 1C elaborate upon present RSVP protocol based optical communication networks (Prior Art).

FIG. 2 illustrates an implementation of method proposed in accordance with an exemplary embodiment of the present disclosure.

FIG. 3 illustrates method proposed in accordance with an exemplary embodiment of the present disclosure.

FIG. 4 elaborates upon structure of a private object of a TLV format in accordance with an exemplary embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Embodiments of the present invention may be provided as a computer program product, which may include a machine-readable storage medium tangibly embodying thereon instructions, which may be used to program a computer (or other electronic devices) to perform a process. The term “machine-readable storage medium” or “computer-readable storage medium” includes, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). A machine-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Embodiments of the proposed invention may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

The present disclosure mainly relates to optical telecom networks. In particular, it relates to a method for equipment selection in a GMPLS network.

In an aspect, present disclosure elaborate upon a method of synchronizing state of a Label Switched Path (LSP) of a Generalized Multiprotocol Label Switching (GMPLS) based optical communication network with that of a data plane of the network. The method includes: receiving, at a network device, Resource ReserVation Protocol (RSVP) path objects that comprise at least one private object, wherein the at least one private object carries information that enables control plane of the network to synchronize at least one node downstream of the LSP; and synchronizing, using the network device, the state of the LSP with state of the data plane based on the at least one private object.

In another aspect, the at least one private object can include one or more specific structures that enable the at least one node to uniquely identify and program equipment operatively connected with the at least one node, wherein the at least one private object can be of Type-Length-Value (TLV) format, and can carry information pertaining to a restoration LSP or a protection LSP.

In an aspect, the at least one private object can piggyback on the RSVP path objects to carry the information from one node to another of the network.

In another aspect, the method can facilitate a mechanism to identify hardware for provisioning of restoration paths in a tunnel following 1+1+R protection scheme.

In another aspect, the control plane can choose the LSP's head node as master and can enforce configuration and card selected to the at least one node. Equipment comprising the nodes in this context can mean, for example, optical Muxponders/transponders and other intermediate optical hardware for a node.

In yet another aspect, the method can be applicable to all network topologies.

In an aspect, the method can enable implementation of ASON (Automatically Switched Optical Network) to create more than two paths to support 1+1+R protection during span of multiple cuts in optical fibre used in the network.

In another aspect, the method can enable the RSVP path objects to link current LSP with all associated LSPs in the network in order to find correct/redundant hardware to be programmed.

In yet another aspect, the method can enable Rx path of various nodes in the LSP to be kept in sync so as to have minimum disruption time.

In an aspect present disclosure elaborates upon a network device configured in a Generalized Multiprotocol Label Switching (GMPLS) based optical communication network having a Label Switched Path (LSP). The network device includes one or more processors coupled with a memory, the memory storing instructions executable by the one or more processors to: receive, at the network device, Resource ReserVation Protocol (RSVP) path objects that comprise at least one private object, wherein the at least one private object carries information that enables control plane of the network to synchronize at least one node downstream of the LSP; and synchronize, using the network device, state of the LSP with data plane of the network based on the at least one private object.

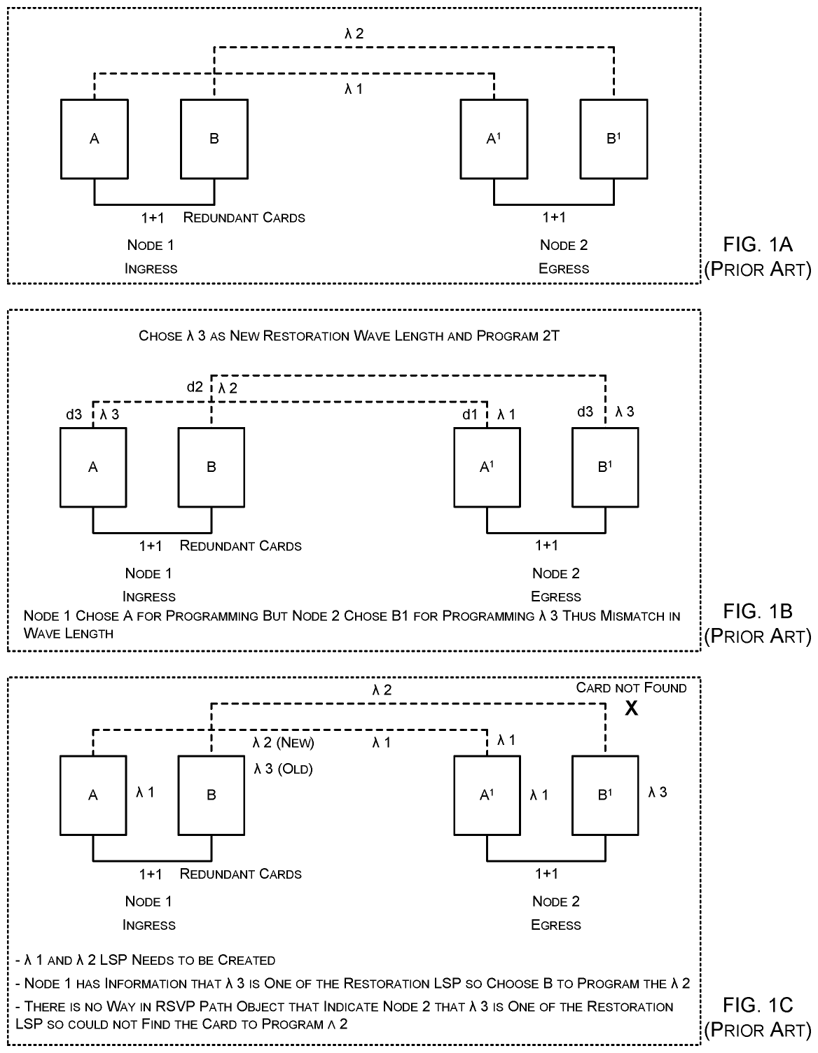

FIGS. 1A to 1C elaborate upon present RSVP protocol based optical communication networks (Prior Art).

As illustrated in FIG. 1A, Node 1 is an ingress node from where a tunnel based on Resource Reservation Protocol—Traffic Engineering (RSVP-TE) originates. Interchangeably, this can be termed as head node of the RSVP-TE tunnel. Node 2 is the egress node where the RSVP-TE tunnel terminates, interchangeably termed as tail node of RSVP-TE tunnel.

A and B indicated are two redundant optical muxponder/transponder cards to be programmed at ingress node. Programming involves assignment of wavelength and direction to the each card (A & B). Likewise, A′ and B′ are two redundant optical muxponder/transponder cards to be programmed at egress node. Programming involves assignment of wavelength and direction to the each card (A′ & B′).

For communication to proceed successfully, A and A′ must be programmed for wavelength and coherent direction in-order to run traffic. Likewise, B and B′ must be programmed for wavelength and coherent direction in-order to run traffic.

In case of DWDM (Dense Wavelength Division Multiplexing) mesh networks there can be more two paths in case of 1+1+R protection scenario.

FIG. 1A illustrates a successful/desired configuration wherein Node 1 can successfully transfer data to Node 2.

FIG. 1B illustrates situation in case a better path is found that needs to be programmed, or in case of any deterioration in existing paths/nodes such as reboot of ingress Node 1 or egress Node 2, or a fault between links.

In such a case a new restoration lambda (lambda indicating a new path/tunnel that can be enabled by optical switching for routing of information) needs to be programmed. Lambda 3 is programmed at A on ingress node but on the egress node there is no mechanism provided in RSVP to find out if this Lambda 3 tunnel needs to be programmed on A′ or B′ in case none of the tunnels are previously programmed. As shown, Lambda 3 tunnel may get programmed for B′ where A′ continues to be on Lambda 1. As can be appreciated, this may lead to error conditions on the egress node 2. As shown in FIG. 1B, Lambda 1 can have a direction d1, Lambda 2 can have a direction d2, and Lambda 3 can have a direction d3.

Further, as illustrated in FIG. 1C, in case B′ on egress node 2 is rebooted and had Lambda 3 configured on it, by the time it boots up, Lambda 2 may get configured on B.

Now when the RSVP tunnel between B and B′ reprogramming starts there is no way for this tunnel to locate B′ on the egress node unless it pairs information about all related tunnels which is not provided in RSVP-TE protocol, as it has information of only working and protection.

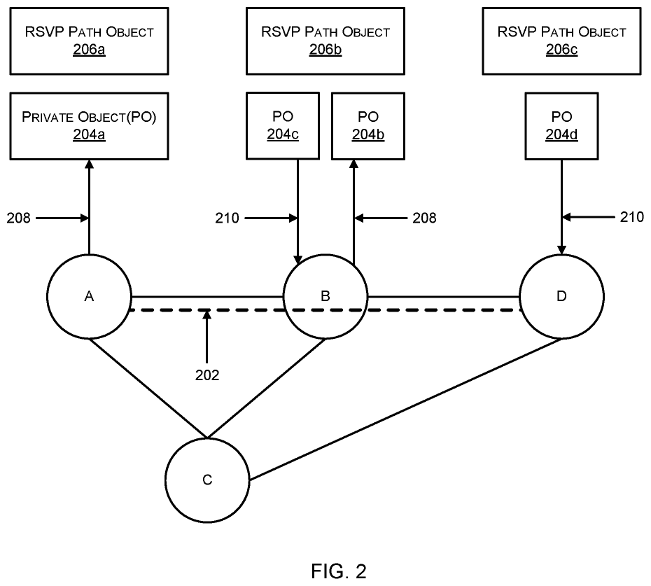

FIG. 2 illustrates an implementation of method proposed in accordance with an exemplary embodiment of the present disclosure.

Method proposed enables taking advantage of loose coupling between Hardware location and the direction it is catering in order to make for an automatically configurable system. Implementation of ASON (Automatically Switched Optical Network)/GMPLS in method proposed can enable creating more than two paths to support the 1+1+R protection during the span of multiple cuts in optical fibre used in the network.

In an aspect, main objective of method proposed is synchronize the state of a label switched path (LSP) in a network with that of data plane of the network, and to facilitate a mechanism to identify the hardware for provisioning of restoration paths in tunnels following 1+1+R protection scheme.

In another aspect, the method proposed follows the principle of RSVP objects containing the TLV (Type-Length-Value) objects that carry information along the path of LSP creation, thereby allowing control plane of the network to synchronize one/more nodes along the downstream path.

In yet another aspect, method proposed makes use of Private Object in TLV format. The private object is carried by/piggybacked upon an RSVP path object. In this manner, information is carried from one node to another.

In an aspect, the control plane can choose LSP head as the master and enforce the configuration and card selected at Head node to all nodes along the path of LSP.

As illustrated in FIG. 2, a network can have various nodes shown as A, B, C and D. Of these, nodes A, B and C can be connected via a label switched path (LSP) shown as 202. Node A can be the head node, while node D can be the tail node. Each node can provide information to a corresponding private object 204 that can in turn be contained/carried/piggybacked over corresponding RSVP path object 206. The information can contain the specific structure that enables the nodes to uniquely identify a network equipment (such as of another node) and program it. In this manner, each private object can contain the specific structure that enables the nodes to uniquely identify various network equipment and program them.

For instance, information regarding cards/equipment pertaining to head end node A can be carried in private object 204a that can in turn piggyback on RSVP path object 206a. Similarly information regarding cards/equipment pertaining to intermediate node B can be carried in private object 204b that can in turn piggyback on RSVP path object 206b.

At any node needed (as shown at 210), private object(s) present in corresponding RSVP Path object can be decoded to get necessary information. For instance, as shown for node D, private object 204d piggybacking on RSVP path object 206c can be decoded to get necessary information to identify and program node D.

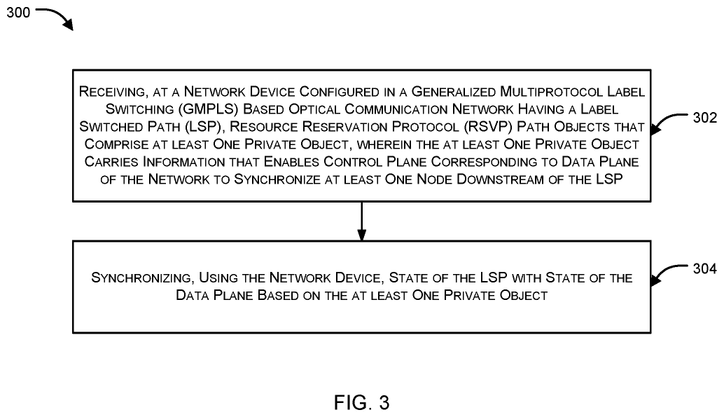

FIG. 3 illustrates method proposed in accordance with an exemplary embodiment of the present disclosure.

As shown in FIG. 3, a method of synchronizing state of a Label Switched Path (LSP) of a Generalized Multiprotocol Label Switching (GMPLS) based optical communication network with that of a data plane of the network can include, at step 302, receiving, at a network device, Resource ReserVation Protocol (RSVP) path objects that comprise at least one private object, wherein the at least one private object carries information that enables control plane corresponding to the data plane to synchronize at least one node downstream of the LSP.

The method can further include, at step 304, synchronizing, using the network device, the state of the LSP with state of the data plane based on the at least one private object.

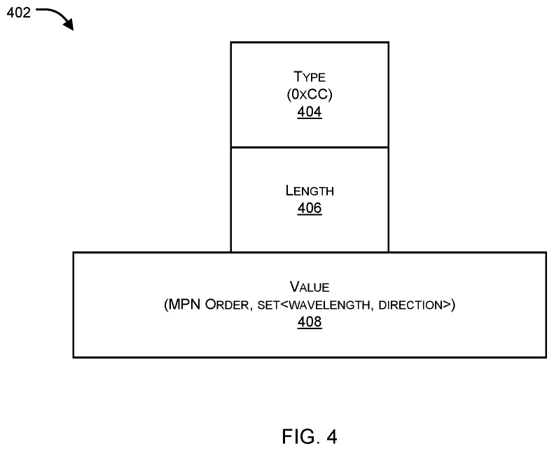

FIG. 4 elaborates upon structure of a private object of a TLV format in accordance with an exemplary embodiment of the present disclosure.

Within data communication protocols, TLV (type-length-value or tag-length-value) is an encoding scheme/format used for optional information element in a certain protocol. The type and length are fixed in size (typically 1-4 bytes), and the value field is of variable size. These fields are used as follows: Type is a binary code, often simply alphanumeric, which indicates the kind of field that this part of the message represents; Length is the size of the value field (typically in bytes); and Value is a variable-sized series of bytes which contains data for this part of the message.

FIG. 4 illustrates a private object 402 in TLV format. As illustrated Type 404 of the private object 402 can be OXCC, while its Value 408 can include MPN Order, set<wavelength and direction>.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### Advantages of the Invention

The present disclosure provides for a method that enables RSVP packets to link current LSP with all associated LSPs in a network in order to find correct/redundant hardware to be programmed.

The present disclosure provides for a method that creates a restoration LSP (Label Switched Path) in addition to working and protection LSP.

The present disclosure provides for a method that keeps Rx path of various nodes in an LSP in sync so as to have minimum service disruption time.

We claim:

1. A method of synchronizing state of a Label Switched Path (LSP) of a Generalized Multiprotocol Label Switching (GMPLS) based optical communication network with that of a data plane of the network, said method comprising:
receiving, at a network device, Resource ReserVation Protocol (RSVP) path objects that comprise at least one private object, wherein the at least one private object carries information that enables control plane of the network to synchronize at least one node downstream of said LSP; and
synchronizing, using the network device, said state of said LSP with state of said data plane based on said at least one private object.

2. The method as claimed in claim 1, wherein said at least one private object comprises one or more specific structures that enable said at least one node to uniquely identify and program equipment operatively connected with said at least one node, and wherein said at least one private object is of Type-Length-Value (TLV) format, and carries information pertaining to a restoration LSP or a protection LSP.

3. The method of claim 1, wherein said at least one private object piggybacks on said RSVP path objects to carry said information from one node to another of said network.

4. The method of claim 1, wherein said method facilitates a mechanism to identify hardware for provisioning of restoration paths in a tunnel following 1+1+R protection scheme.

5. The method of claim 1, wherein said control plane chooses said LSP's head node as master and enforces configuration and card selected to said at least one node.

6. The method of claim 1, wherein the method is applicable to all network topologies.

7. The method of claim 1, wherein the method enables implementation of ASON (Automatically Switched Optical Network) to create more than two paths to support 1+1+R protection during span of multiple cuts in optical fibre used in the network.

8. The method of claim 1, wherein said method enables said RSVP path objects to link current LSP with all associated LSPs in said network in order to find correct/redundant hardware to be programmed.

9. The method of claim 1, wherein said method enables Rx path of various nodes in said LSP to be kept in sync so as to have minimum disruption time.

10. A network device configured in a Generalized Multiprotocol Label Switching (GMPLS) based optical communication network having a Label Switched Path (LSP), said network device comprising one or more processors coupled with a memory, the memory storing instructions executable by the one or more processors to:
receive, at the network device, Resource ReserVation Protocol (RSVP) path objects that comprise at least one private object, wherein the at least one private object carries information that enables control plane of the network to synchronize at least one node downstream of said LSP; and
synchronize, using the network device, state of said LSP with data plane of said network based on said at least one private object.
